(19) United States
(12) Patent Application Publication
(10) Pub. No.: US 2014/0078754 A1
(43) Pub. Date: Mar. 20, 2014

(54) LAMP WITH HEAT DISSIPATING APPARATUS

(71) Applicant: Coselig Technology Corporation, Taipei (TW)

(72) Inventors: Mao-Chang YANG, Taipei (TW); Chih-Kai HSU, Taipei (TW)

(73) Assignee: Coselig Technology Corporation, Taipei (TW)

(21) Appl. No.: 14/023,886

(22) Filed: Sep. 11, 2013

(30) Foreign Application Priority Data
Sep. 14, 2012 (TW) 101217853

(51) Int. Cl. F21V 29/00

(52) U.S. Cl. CPC F21V 29/004
USPC 362/373

(57) ABSTRACT

A lamp which includes an outer barrel, a light barrel, a plurality of fins, a heat-conducting disk, a LED module, a first lid and a second lid. The light barrel is received in the outer barrel, and has an inner thread. The fins connect an inner side of the outer barrel and an outer side of the light barrel. The heat-conducting disk has an outer thread on an edge which is to be meshed with the inner thread of the light barrel. The LED module is mounted on the heat-conducting disk. The first lid and the second lid engages two ends of the light barrel. An opening of the first lid communicates an opening at the end of the light barrel, and an opening of the second lid communicates another opening at the opposite side. Therefore, the heat generated by the LED module could be dissipated via the heat-conducting disk.

The current application claims a foreign priority to the patent application of Taiwan No. 101217853 filed on Sep. 14, 2012.

### BACKGROUND OF THE INVENTION

1. Technical Field

The present invention relates to a lighting device, and more particularly to a lamp having a heat dissipating apparatus.

2. Description of Related Art

Comparing to the traditional lamps, such as fluorescent lamp and incandescent lamp, LED lamp has many advantages, including low power consumption, long product life, low radiant heat, and so on. More and more traditional lamps are replaced by the LED lamps. High luminance LED lamps are more and more popular in the present market. The major problem of the high luminance LED lamps in present days is heat, so that how to get a good heat dissipation in the LED lamps is very important. Taiwan Utility Model M411529 teaches a heat dissipating apparatus, which is secured in a LED lamp by a locking member. Such heat dissipating apparatus has the following drawbacks:

1. The heat dissipating apparatus only has a very small area to contact the LED module, which is bad for heat dissipation.

2. It is not easy to secure the dissipating apparatus by the locking member because the installation process needs several elements to be controlled at the same time.

Therefore, the conventional dissipating apparatus for the lamp still is needed to improve.

### BRIEF SUMMARY OF THE INVENTION

In view of the above, the primary objective of the present invention is to provide a lamp, which has a good performance in heat dissipation and is easy to replace the LED module.

The present invention provides a lamp with heat dissipating apparatus, which includes a light barrel, a heat-conducting disk and a LED module, wherein the light barrel has two openings at opposite ends thereof and an inner thread on an inner side thereof; the heat-conducting disk has an outer thread and at least a assembling bore, wherein the outer thread is on an edge of the heat-conducting disk to be meshed with the inner thread of the light barrel; and the LED module is mounted on the heat-conducting disk.

With such design, the heat dissipation efficiency of the lamp is higher, and the LED module is easy to be replaced.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first preferred embodiment of the present invention;

FIG. 2 is another perspective view of the first preferred embodiment of the present invention;

FIG. 3 is an exploded view of the first preferred embodiment of the present invention;

FIG. 4 is a sectional view of the first preferred embodiment of the present invention;

FIG. 5A is a perspective view of the first preferred embodiment of the present invention, showing the LED module being mounted on the heat-conducting disk;

FIG. 5B is a perspective view of the first preferred embodiment of the present invention, showing the power wire and the ground wire being secured on the heat-conducting disk;

FIG. 6 is a perspective view of a second preferred embodiment of the present invention;

FIG. 7 is a sectional view of the 7-7 line in FIG. 6;

FIG. 8 is a sectional view of the second preferred embodiment of the present invention, showing the heat-dissipating barrel on the bottom of the light barrel;

FIG. 9 is a sectional view of a third preferred embodiment of the present invention;

FIG. 10 is a sectional view of a fourth preferred embodiment of the present invention;

FIG. 11 is a perspective view of a fifth preferred embodiment of the present invention;

FIG. 12 is a sectional view of the 12-12 line in FIG. 11; and

FIG. 13 is a sectional view of a sixth preferred embodiment of the present invention.

### DETAILED DESCRIPTION OF THE INVENTION

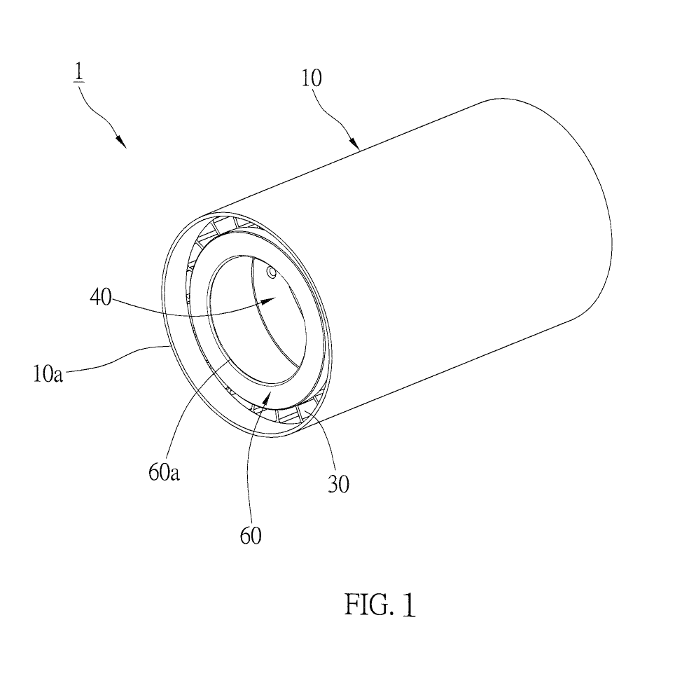

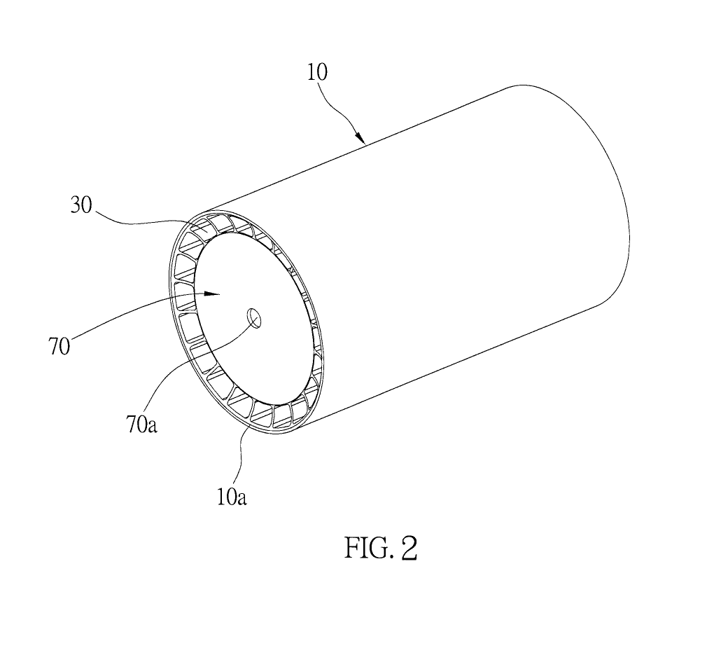

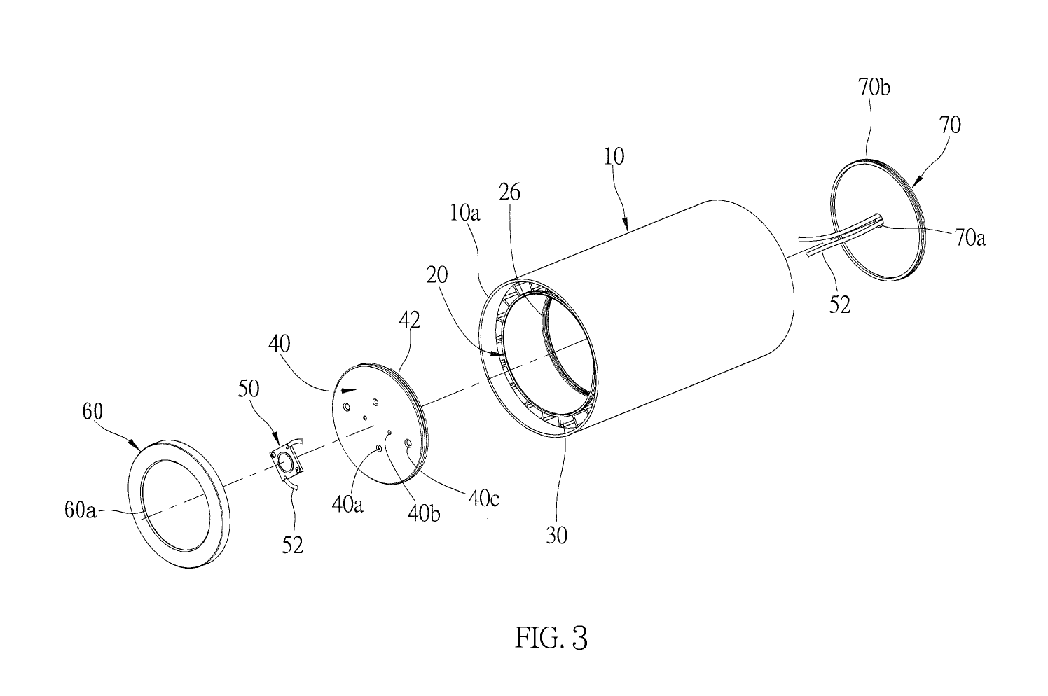

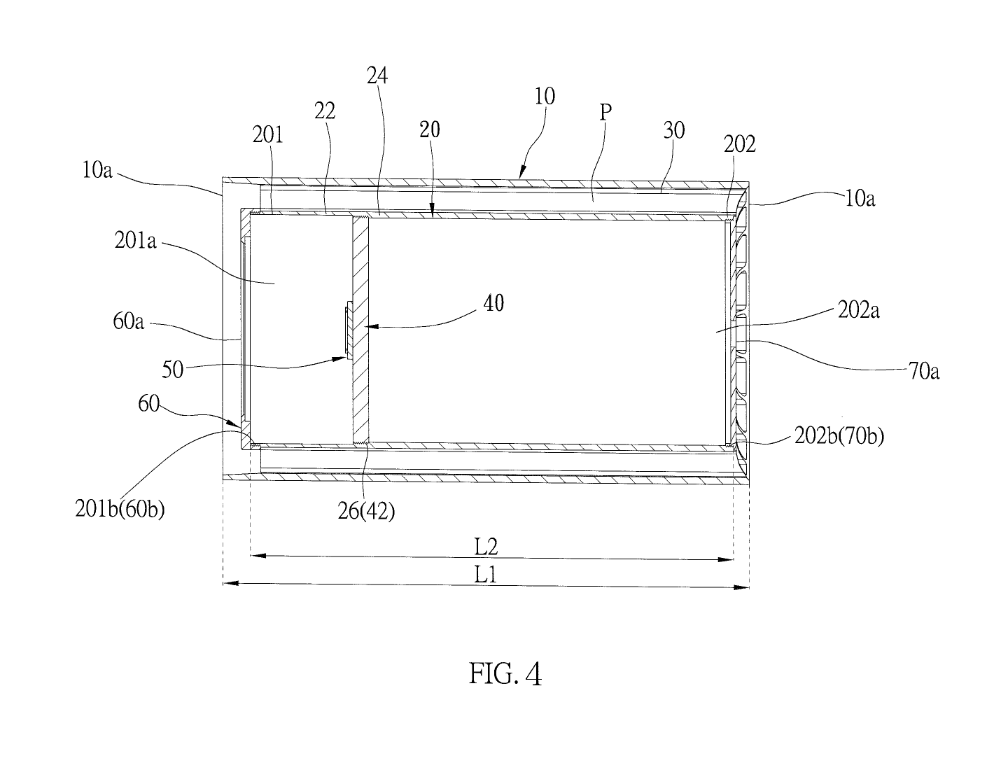

As shown in FIG. 1 to FIG. 4, a lamp 1 of the first preferred embodiment of the present invention includes an outer barrel 10, a light barrel 20, a plurality of fins 30, a heat-conducting disk 40, a LED module 50, a first lid 60, and a second lid 70.

The outer barrel 10 has two openings 10a at opposite ends. A length L1 of the outer barrel 10 is longer than a length L2 of the light barrel 20. In the present embodiment, the outer barrel 10 is a round barrel, and it could be a polygonal barrel in other embodiments as well.

The light barrel 20 has a first end 201 and a second end 202, and has two openings 201a, 202a at the first and second ends 201, 202 respectively. The outer barrel 10 and the light barrel 20 are coaxial. The light barrel 20 has a first section 22 and a second section 24, and the first section 22 has a larger inner diameter than the second section 24. The light barrel 20 is provided with an inner thread 26 on an inner side of the second section 24, and the inner thread 26 is adjacent to the first section 22. The light barrel 20 further is provided with an outer thread 201b adjacent to the first end 201 and an inner thread 202b adjacent to the second end 202.

The fins 30 have opposite ends connected to an inner side of the outer barrel 10 and an outer side of the light barrel 20. The fins 30 extend from the first end 201 to the second end 202. Therefore, a plurality of passageways P are formed between the fins 30 for convection. In the present embodiment, the outer barrel 10, the light barrel 20, and the fins 30 are made into a single unit that may reduce the cost.

The heat-conducting disk 40 is an aluminum round disk. It has an outer thread 42 on an edge thereof to be meshed with the inner thread 26 of the light barrel 20. Teeth of the inner thread 26 and the outer thread 42 increase the contact area between the light barrel 20 and the heat-conducting disk 40 to enhance the conduction. In consideration of manufacture and heat dissipation, the best place for the outer thread 42 is the outmost edge of the heat-conducting disk 40. The heat-conducting disk 40 has two first bores 40a, two second bores 40b and two assembling bores 40c. User may use a specified tool (or even by fingers) to engage the assembling bores 40c and screw the heat-conducting disk 40 into the light barrel 20. In practice, the heat-conducting disk 40 may have an assembling bore 40c only.

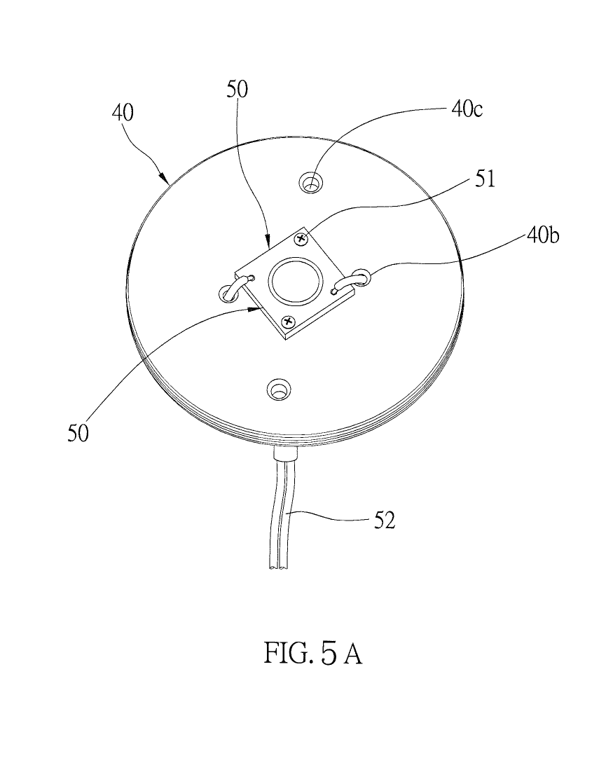

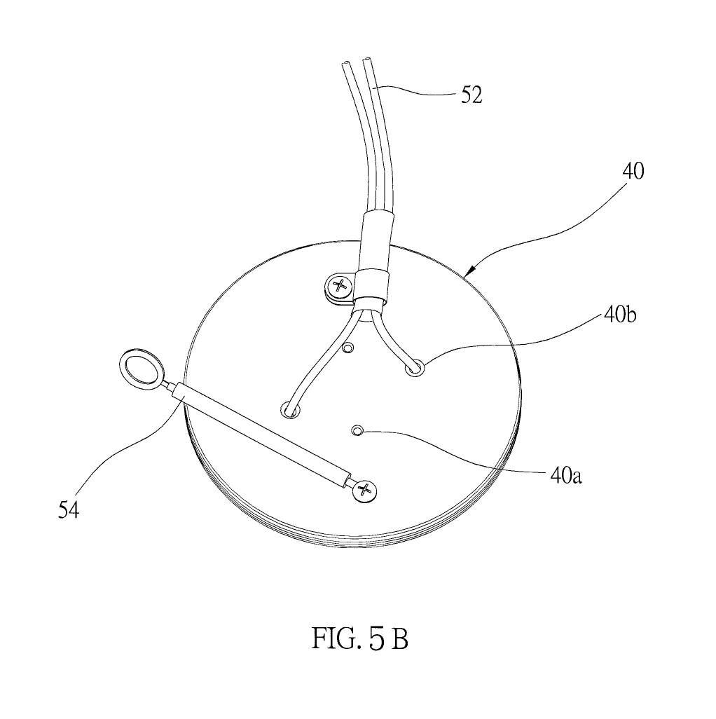

The LED module 50 is mounted on a center of the heat-conducting disk 40. Heat of the LED module is conducted to the center of the heat-conducting disk 40, and then conducted from the center to the edge of the heat-conducting disk 40, and finally to the light barrel 20. Some of the heat is dissipated by air convection through the surface of the heat-conducting disk 40. As shown in FIG. 5A and FIG. 5B, a fastener, which is a bolt 51 in the present embodiment, is screwed into the first bore 40a to secure the LED module 50 on the heat-conducting disk 40. The LED module 50 has power wires 52 and ground wires 54, wherein the power wires 52 pass through the second bores 40b, and the ground wires 54 may be secured in the assembling bores 54.

The first lid 60 is connected to the first end 201 of the light barrel 20. The first lid 60 has an opening 60a communicated with the opening 201a at the first end 201. In the present embodiment, the first lid 60 has an inner thread 60b to be meshed with the outer thread 20 lb of the light barrel 20. In practice, the first lid 60 may have an outer thread to be meshed with the inner thread of a light barrel. The first lid 60 may be provided with a diffuser film or a lens for specific optical performance, such as light softening or light focusing.

The second lid 70 is connected to the second end 202 of the light barrel 20. The second lid 70 has an opening 70a communicated with the opening 202a at the second end 202 for the power wires entering the light barrel 20. In the present embodiment, the second lid 70 has an outer thread 70b to be meshed with the inner thread 202b of the light barrel 20. In practice, the second lid 70 may have an inner thread to be meshed with the outer thread of a light barrel.

Any engaging ways, except the thread, may be applied in the present invention to engage the lids 60, 70 with the light barrel 20.

The light barrel 20 has a chamber S in the first section 22, and the first lid 60 closes the chamber S. Optical elements, such as reflective lens (not shown), may be received in the chamber. The reflective lens reflects the light of LED module 50 to emit the light through the opening 60a of the first lid 60. The heat-conducting disk 40 is received in the chamber S and is kept a distance away from the first end 201. The heat-conducting disk 40 enters the light barrel 20 through the first end 201, and goes through the first section 22, and finally is meshed with the inner thread 26 at the second section 26. In Taiwan M411539 patent, there is no chamber in the barrel, therefore any reflective lens cannot be received therein.

In comparison with Taiwan M411539 patent, the length L1 of the outer barrel 10 is longer than the length L2 of the light barrel 20, which may reduce the scattering effect of the light emitted from the first end 201 of the light barrel 20 and hide the fins 30 therein. Besides, the outer barrel 10 is helpful to the heat dissipation because it has a large area in contact with air.

In the present invention, heat of the LED module 50 is transferred to the outer barrel 10 through the heat-conducting disk 40, the light barrel 20, and the fins 30 by conduction, and then the heat is dissipated through the fins 30 and through the outer barrel 10 by convection. The thickness or the material of the heat-conducting disk 40 and the lengths of the outer barrel 10, the light barrel 20 and the fins 30 may be changed for different requirements. The outer barrel 10 may be provided with openings (not shown) in communication with the passageways P to enhance the convection efficiency. In an embodiment, there is another outer barrel and fins (not shown) connected to the outer barrel 10 to obtain better heat dissipation performance. In another embodiment, only the light barrel 20 and the fins 30 are provided for a LED module which generates less heat. Sometime, the fins 30 may be omitted.

If the LED module 50 needs to be replaced, user only has to loosen the heat-conducting disk 40, take it out, and then loosen the bolt 51 to replace the LED module 50. No precise alignment is needed, and therefore the replacement is easy to be done.

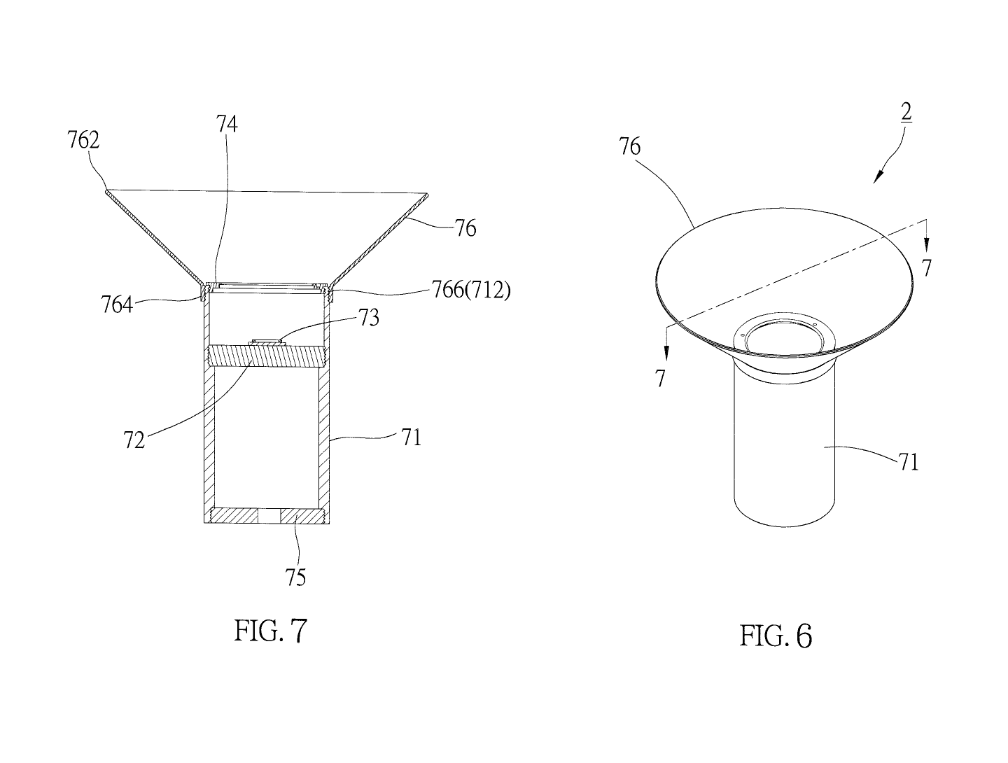

FIG. 6 and FIG. 7 show a lamp 2 of the second preferred embodiment of the present invention, which is similar to the lamp 1 of the first preferred embodiment, including a light barrel 71, a heat-conducting disk 72, a LED module 73, a first lid 74, and a second lid 75. The lamp 2 further includes a heat-dissipating barrel 76, which has a first end 762 and a second end 764. The heat-dissipating barrel 76 is a tapered barrel, and a diameter thereof gradually reduces from the first end 762 to the second end 764.

The heat-dissipating barrel 76 has an inn thread 766 on an inner side adjacent to the first end 764. The light barrel 71 has an outer thread 712 on an outer side adjacent to a top thereof to engage the inn thread 766 of the heat-dissipating barrel 76. The inn thread 766 forms a first coupling portion of the heat-dissipating barrel 76, and the outer thread 712 forms a second coupling portion of the light barrel 71. Heat of the LED module 73 is transferred to the heat-dissipating barrel 76 through the light barrel 71 for heat dissipation. The tapered heat-dissipating barrel 76 provides a large surface area (compare with a straight heat-dissipating barrel with the same length) for heat dissipation that the heat of the LED module 73 is quickly dissipated through the heat-dissipating barrel 76 and the light barrel 71.

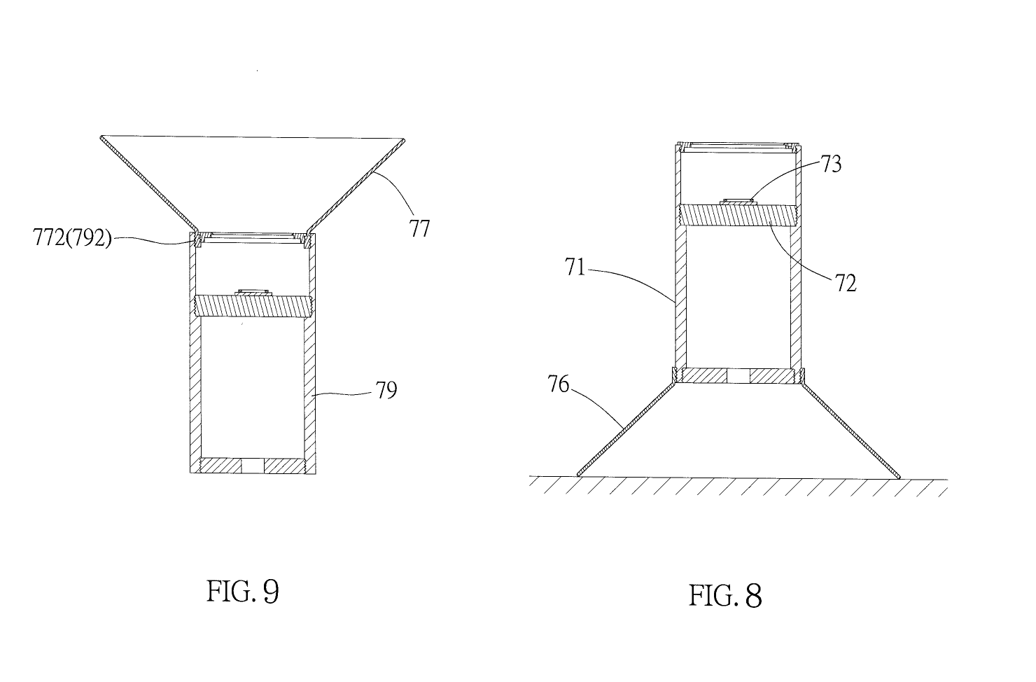

FIG. 8 shows the outer thread 712 is adjacent to a bottom of the light barrel 71. While the light barrel 71 is engaged with the heat-dissipating barrel 76, the heat-dissipating barrel 76 is a stand of the lamp 2 allowing the lamp 2 to be stably put on a table.

FIG. 9 shows a lamp 3 of the third preferred embodiment of the present invention, which is similar to the lamp 2 of the second preferred embodiment, except that a heat-dissipating barrel 77 has an outer thread 772, and a light barrel 79 has an inner thread 792. The heat-dissipating barrel 77 is connected to the light barrel 79 by an engagement of the outer thread 772 and the inner thread 792. For this design, the heat-dissipating barrel 77 may be the stand of the lamp 3 like FIG. 8 as well while the inner thread 792 is adjacent to a bottom the light barrel 79.

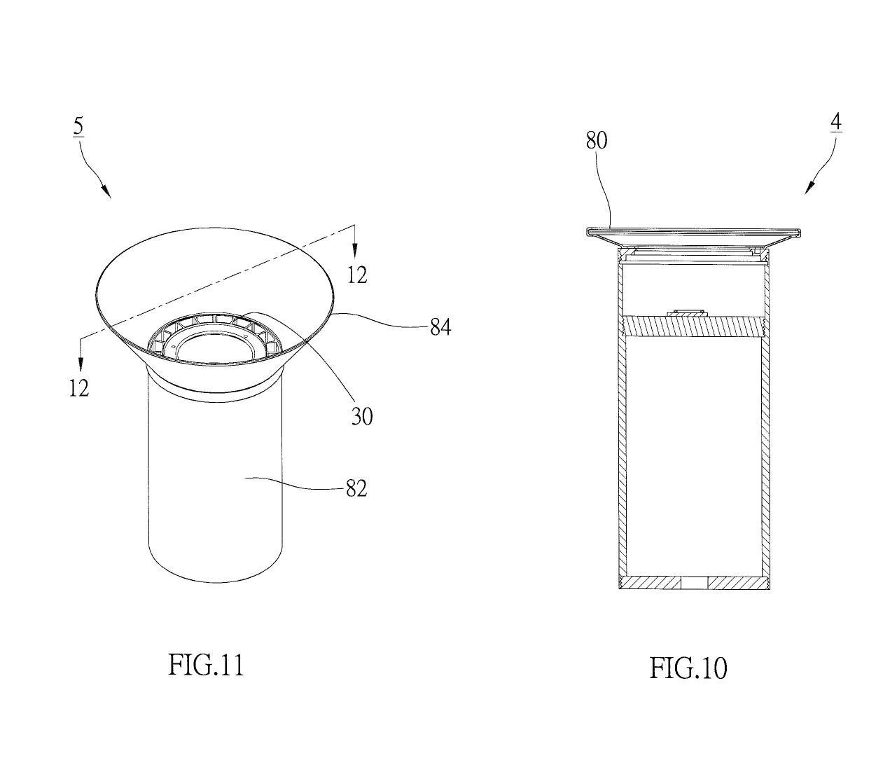

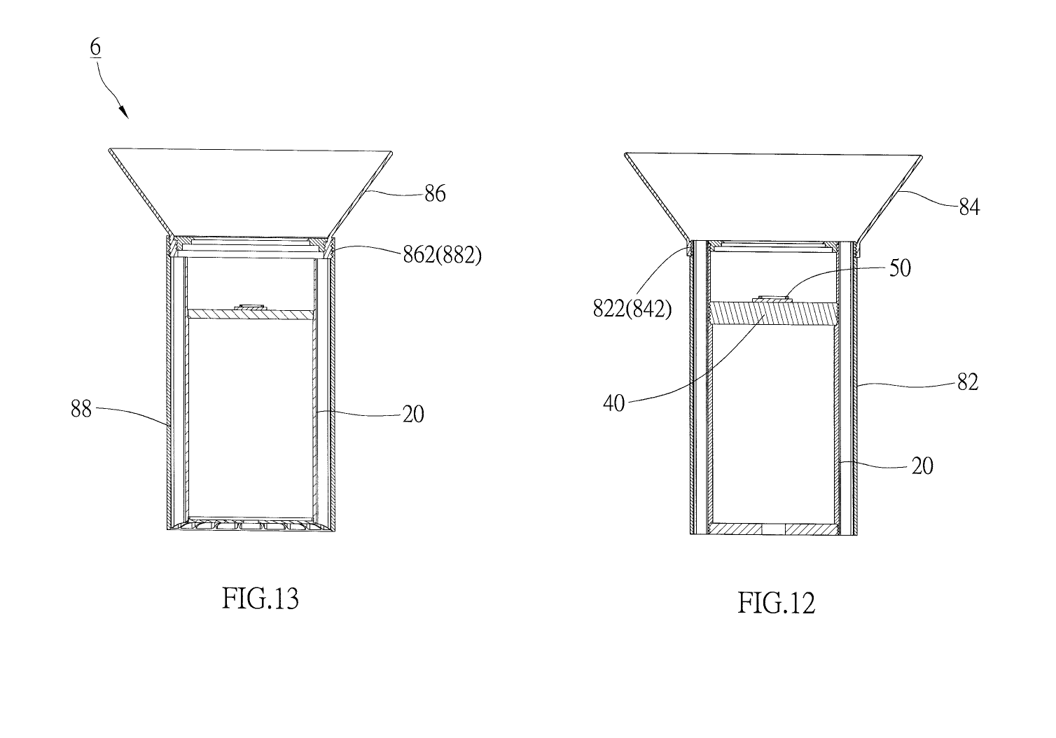

FIG. 10 shows a lamp 4 of the fourth preferred embodiment of the present invention, which is similar to the lamps of above preferred embodiments, except that a tapered heat-dissipating barrel 80 is shorter than the heat-dissipating barrels of above preferred embodiments, but the diameters of the first end and the second end are the same as above. This heat-dissipating barrel 80 provides a wide range of light projection. It may provide the heat-dissipating barrels of different sizes for replacement. FIG. 11 and FIG. 12 show a lamp 5 of the fifth preferred embodiment of the present invention, which is similar to the lamp 1 of the first preferred embodiment, including a light barrel 20, the fins 30, the heat-conducting disk 40, and the LED module 50. A length of an outer barrel 82 is the same as that of the light barrel 20. The outer barrel 82 is provided with an outer thread 822 adjacent to a top thereof. The lamp 5 has a heat-dissipating barrel 84 also, which has an inner thread 842 to engage the outer thread 822 of the outer barrel 82. The outer barrel 82 and the heat-dissipating barrel 84 provide a large surface area for heat dissipation. The heat-dissipating barrel 84 can be a stand of the lamp 5 as shown in FIG. 8.

FIG. 13 shows a lamp 6 of the sixth preferred embodiment of the present invention, which is similar to the lamp 5 of the fifth preferred embodiment, except that a heat-dissipating barrel 86 has an outer thread 862, and a light barrel 88 has an inner thread 882. The heat-dissipating barrel 86 is connected to the light barrel 88 by an engagement of the outer thread 862 and the inner thread 882. The heat-dissipating barrel 86 can be a stand of the lamp 6 as shown in FIG. 8.

In the second preferred embodiment to the sixth preferred embodiment, the heat-dissipating barrel is provided to connect to the outer barrel or the light barrel. The heat-dissipating barrel increases the surface area for heat dissipation. In the embodiments of the present invention, the heat-dissipating barrel is connected to the outer barrel or the light barrel through threads, however, any equivalent connecting means may be applied in the present invention. Beside, except on the opposite ends of the outer barrel or the light barrel, the heat-dissipating barrel may be provided on a middle of the outer barrel or the light barrel.

It must be pointed out that the embodiments described above are only some preferred embodiments of the present invention. All equivalent structures which employ the concepts disclosed in this specification and the appended claims should fall within the scope of the present invention.

What is claimed is:

1. A lamp, comprising:
a light barrel having two openings at opposite ends thereof and an inner thread on an inner side thereof;
a heat-conducting disk having an outer thread and at least a assembling bore, wherein the outer thread is on an edge of the heat-conducting disk to be meshed with the inner thread of the light barrel; and
a LED module mounted on the heat-conducting disk;
wherein the light barrel is provided with a plurality of fins on an outer side thereof.

2. The lamp of claim 1, further comprising an outer barrel, in which the light barrel is received, wherein the fins are in contact with an inner side of the outer barrel, and a length of the outer barrel is longer than that of the light barrel.

3. The lamp of claim 1, wherein the light barrel has a first section and a second section; a diameter of the first section is greater than that of the second section; and the inner thread is provided at the second section.

4. The lamp of claim 1, further comprising a first lid engaging the opening of the light barrel, wherein the first lid has an opening.

5. The lamp of claim 4, wherein the first lid has an inner thread to engage an outer thread of the light barrel.

6. The lamp of claim 1, further comprising a first lid and a second lid respectively engaging the openings of the light barrel, wherein the first lid and the second lid respectively have an opening.

7. The lamp of claim 6, wherein the first lid has an inner thread to engage an outer thread of the light barrel, and the second lid has an outer thread to engage an inner thread of the light barrel.

8. The lamp of claim 1, wherein the heat-conducting disk has several bores for securing the LED module on the heat-conducting disk by a fastener, and for power wires of the LED module passing therethrough.

9. The lamp of claim 1, wherein the heat-conducting disk is made of aluminum.

10. The lamp of claim 1, wherein the outer thread is at the outmost edge of the heat-conducting disk.

11. The lamp of claim 1, further comprising a heat-dissipating barrel, which has a first end and a second end, wherein a diameter of the heat dissipating barrel gradually reduces from the first end to the second end; the heat-dissipating barrel has a first coupling portion on the second end, and the light barrel has a second coupling portion to engage the first coupling portion of the heat-dissipating barrel.

12. The lamp of claim 1, further comprising an outer barrel and a heat-dissipating barrel, wherein the light barrel is received in the outer barrel, and the fins are in contact with the outer barrel; the heat-dissipating barrel has first end and a second end, and a diameter of the heat dissipating barrel gradually reduces from the first end to the second end; the heat-dissipating barrel has a first coupling portion on the second end, and the outer barrel has a second coupling portion to engage the first coupling portion of the heat-dissipating barrel.

13. The lamp of claim 2, further comprising a heat-dissipating barrel, which has a first end and a second end, wherein a diameter of the heat dissipating barrel gradually reduces from the first end to the second end; the heat-dissipating barrel has a first coupling portion on the second end, and the outer barrel has a second coupling portion to engage the first coupling portion of the heat-dissipating barrel.
